(19) United States
(12) Patent Application Publication
(10) Pub. No.: US 2015/0002926 A1
(43) Pub. Date: Jan. 1, 2015

(54) Reflective Mold Apparatus and Methods for UV Curing

(71) Applicant: Motorola Mobility LLC, Libertyville, IL (US)

(72) Inventors: Anwar Matarieh, Orlando Park, IL (US); Matthew R. Michieli, South Elgin, IL (US)

(21) Appl. No.: 13/928,650

(22) Filed: Jun. 27, 2013

(51) Int. Cl. G02B 17/08; B32B 37/24

(52) U.S. Cl. CPC G02B 17/0892; B32B 37/24; B32B 2037/243
USPC 359/355; 156/275.5; 156/242

(57) ABSTRACT

An optically clear adhesive (22) couples a lens assembly (12) and a display assembly (14) in an mobile electronic device (200). The optically clear adhesive (22) is at least partially cured from UV light (24) provided from a UV light source (26) reflected from a reflective surface (30) coupled to an interior surface (20) of a housing (16) surrounding the lens assembly (12) and display assembly (14). In an embodiment, the reflective surface (30) is a reflective paint (30A) applied to the interior surface (20) of the housing (16). In another embodiment, the housing (16) is insert molded around a reflective insert (30B) that includes the reflective surface (30).

### TECHNICAL FIELD

The present disclosure relates in general to curing of optically clear adhesives for the display of a mobile electronic device, and, in particular, to methods and apparatus for directing UV light for the curing of an adhesive.

### BACKGROUND

Transparent lenses are used to provide structure and protection to displays, such as on mobile phones and other electronic devices. Lenses are typically coupled to displays through an optically clear adhesive that is cured by exposure to ultra-violet (UV) light.

In some electronic devices, an ink layer or art work is provided around the edges of the device. This ink or art work layer reduces the amount of UV light exposed to the optically clear adhesive under the layer, reducing the effectiveness of the cure.

Optically cured adhesive that is not fully cured can lead to de-lamination of the lens and display assemblies. The de-lamination can lead to field or manufacturing defects along the edge of the display.

### BRIEF DESCRIPTION OF THE DRAWINGS

FIG. 1 illustrates an exemplary electronic device sub-assembly having a housing including a reflective paint layer during a curing process.

FIG. 2 is an enlarged view of a portion of FIG. 1 showing the reflective paint layer of the housing.

FIG. 3 illustrates an exemplary electronic device sub-assembly having a housing including a reflective polymeric material insert molded into the housing during a curing process.

FIG. 4 is an enlarged view of a portion of FIG. 3 showing the reflective polymeric material insert molded into the housing.

FIG. 5 is a schematic of an exemplary mobile electronic device including a housing with an internal reflective surface.

FIG. 6 is a schematic showing illustrative components of the mobile electronic device of FIG. 5.

FIG. 7 is a flow chart of an exemplary process for making a mobile electronic device including a housing with an internal reflective surface.

FIG. 8 is a flow chart of an exemplary process for applying a reflective paint to an internal surface of a housing.

FIG. 9 is a flow chart of an exemplary process for insert molding a material having a reflective surface to an internal surface of a housing.

FIG. 10 is a flow chart of an exemplary process for affixing a reflective film to an internal surface of a housing.

### DETAILED DESCRIPTION OF EXEMPLARY EMBODIMENTS

Briefly, in a specific embodiment, an optically clear adhesive coupling a lens assembly and a display assembly enclosed in a housing of an electronic device is at least partially cured using UV light reflected from a reflective surface of the housing.

In a more particular embodiment, the reflective surface is a reflective paint applied to an internal wall of the housing. In another more particular embodiment, the housing is insert molded around a reflective insert that forms the reflective surface.

In one embodiment, a method for curing a light-cured adhesive is provided. The method includes providing the adhesive between two surfaces to be cured. The adhesive is then cured by applying light from a light source to the adhesive. At least a portion of the adhesive is cured by light that has reflected off of a reflector coupled to one of the two surfaces.

In another embodiment, a sub-assembly for an electronic device is provided. The sub-assembly includes a lens assembly and a display assembly surrounded by a housing. The lens and display assemblies are coupled by an optically clear adhesive. The adhesive is a light-curable adhesive. A light reflector is coupled to the housing. The light reflector is positioned to reflect light from a light source towards a portion of the optically clear adhesive to cure a portion of the optically cure adhesive with the reflected light.

In still another embodiment, a mobile electronic device is provided. The mobile electronic device includes a lens assembly and a display assembly surrounded by a housing. The lens and display assemblies are coupled by an optically clear adhesive. The adhesive is a light-curable adhesive. A light reflector is coupled to the housing. The light reflector is positioned to reflect light from a light source towards a portion of the optically clear adhesive to cure a portion of the optically cure adhesive with the reflected light.

Among other advantages, utilizing a reflective surface in the housing provides light to areas where direct light is not possible, such as along edges of a mobile electronic device and in areas in which an ink or art work layer prevents direct light from reaching the adhesive. Providing light to these areas reduces defects in the adhesion and decreases in delamination.

In embodiments in which the reflective surface is a metallic paint, an additional advantage is provided wherein a thin layer of paint can provide an adequate reflective surface. This allows for a thinner housing, which may be desirable.

In embodiments in which the housing is insert molded around the reflective surface, an additional advantage is that less processing steps may be required. Other additional advantages include lower thickness variation, reduced processing time, and higher yield/less waste.

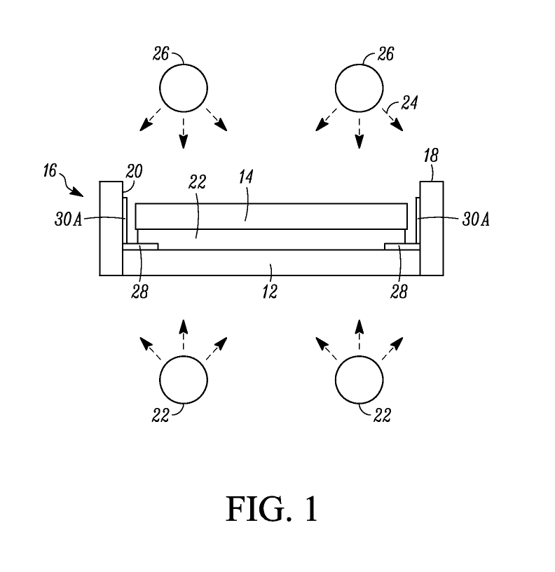

Turning now to the drawings, and as described in detail below, in FIG. 1, a sub-assembly 10 for an electronic device is illustrated. The sub-assembly 10 illustratively includes a lens assembly 12 and a display assembly 14 surrounded by a housing 16.

Lens assembly 12 illustratively includes a transparent lenses are used to provide structure and protection to displays, such as on mobile phones. Typical lenses include glass lenses and plastic lenses. Exemplary glass lenses include lenses such as Gorilla Glass, available from Corning Incorporated, Dragontail, available from Asahi Glass Co., Ltd., and Xensation, available from SCHOTT North America, Inc., that are formed from alumino-silicate glass that is hardened or strengthened by using a potassium or lithium ion bath. Exemplary plastic lenses include lenses formed from polycarbonate (PC) and poly(methyl methacrylate) (PMMA). The lens assembly 12 may further include additional coatings (not shown), including abrasion resistant coatings and hydrophobic anti-finger print coatings.

Display assembly 14 illustratively includes a touch panel or other suitable display. Typical displays include an indium-tin oxide (ITO) capacitive sensor or other transparent conductors such as graphene, carbon nanotube, metal copper or silver nano mesh, a bus assembly, and protective layers, such as formed from polyethylene terephthalate (PET) or other suitable material. Exemplary displays include liquid crystal display (LCD), organic light-emitting diode (OLED), plastic OLED, and e-ink type displays.

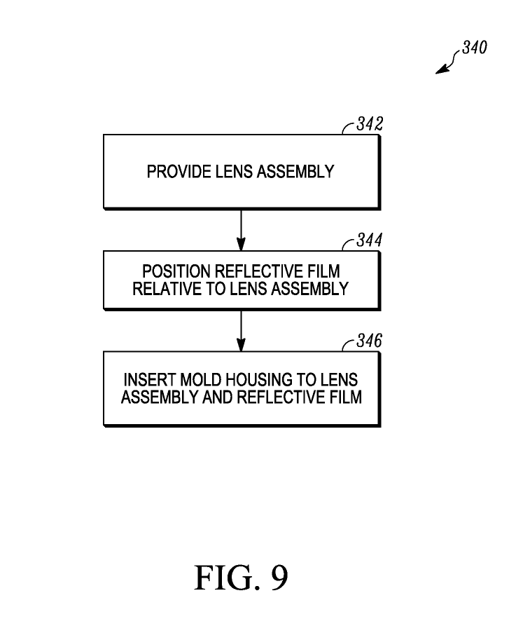

Housing 16 illustratively defines a side surface for sub-assembly 10. As illustrated in FIG. 1, housing 16 surrounds and protects the sides of lens assembly 12 and display assembly 14. In exemplary embodiments, housing 16 may be formed from a polymeric material, such as a plastic, thermoplastic, thermoset, or from a metallic or other suitable material. As described with respect to FIG. 9 below, in an exemplary embodiment, housing 16 is formed from an injectable polymeric material capably of being insert molded one or more of the lens assembly 12 and/or reflective surface 30. In exemplary embodiments, insert molding refers to injecting a molten material, typically a plastic or other polymeric material, into a mold that has been pre-loaded with one or more inserts, resulting in a component comprising both the insert and the molded polymeric material. Typical injectable polymer materials include polycarbonate and other suitable polymeric materials. In another embodiment, housing 16 is formed separately from one or more of lens assembly 12 and/or reflective surface 30 and is later coupled to lens assembly 12 and/or reflective surface 30 through the use of an adhesive, mechanical coupler, friction fit, or other suitable means.

As illustrated in FIG. 1, housing 16 includes vertically extending wall 18 defining an interior surface 20. In one exemplary embodiment, vertically extending wall 18 is substantially perpendicular to lens assembly 12. In another exemplary embodiment, vertically extending wall 18 is not substantially perpendicular to lens assembly 12.

As illustrated in FIG. 1, lens assembly 12 is coupled to display assembly by an optically clear adhesive 22. In an exemplary embodiment, optically clear adhesive 22 allows an image displayed on display assembly 12 to be visible through lens assembly 14. Typical optically clear adhesives 22 include optically clear resins, such as available from Kyoritsu Chemical & Co., Ltd., Tokyo, Japan, and other suitable adhesives.

The optically clear adhesive 22 is applied in an uncured state. As described in more detail below, in a typical embodiment, the optically clear adhesive 22 is applied to a surface of the lens assembly 12. The display assembly 14 is then pressure dropped on to the optically clear adhesive 22, producing a layer of uncured optically clear adhesive 22 between the lens assembly 12 and display assembly 14.

Light 24 emitted from light sources 26 is used to crosslink, or cure, the optically clear adhesive 22. As illustrated in FIG. 1, two light sources 26 are provided above the sub-assembly 10 and two light sources 26 are provided below the sub-assembly 10. In other embodiments, more or fewer light sources 26 may be provided, and they may be positioned in any suitable arrangement to provide light 24 to cure the optically clear adhesive 22. Typically, the light 24 is ultra-violet (UV) light and light sources 26 are UV light sources. In one exemplary embodiment, the sub-assembly 10 containing the uncured optically clear adhesive 22 is exposed to UV light for about 2 minutes to cure the optically clear adhesive 22.

As illustrated in FIG. 1, lens assembly 12 further includes cosmetic ink 28. In other embodiments, cosmetic ink 28 may be provided with display assembly 14. Cosmetic ink may, for example, be used around an exterior border of lens assembly 12 to provide a visual border around the display screen. Cosmetic ink 28 is typically opaque or otherwise reduces the amount of light 24 able to penetrate through sub-assembly 10 and reach the optically clear adhesive 22 to cure the optically clear adhesive 22.

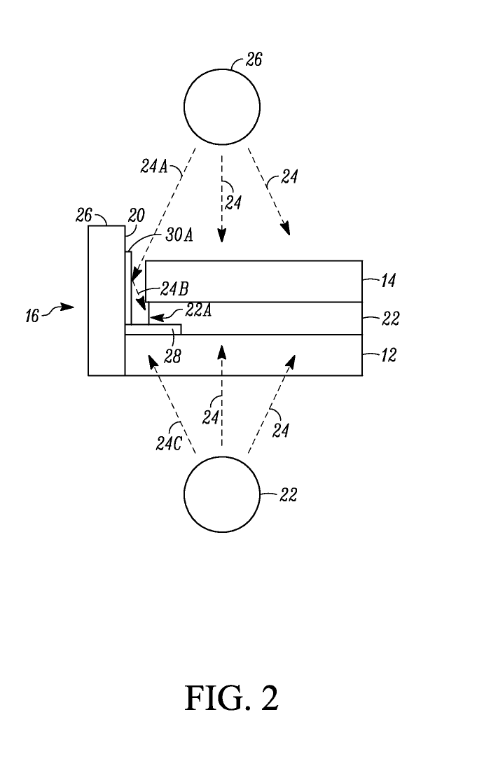

FIG. 2 illustrates an enlarged portion of the sub-assembly 10 of FIG. 1. At least a portion 24C of light 24 emitted from the light sources 26 is unable to reach the uncured optically clear adhesive 22 due to the cosmetic ink 28. An edge portion 22A of optically clear adhesive 22 that does not receive light 24C due to the cosmetic ink 28 may not fully crosslink or cure.

A reflective surface 30 provided on interior surface 20 reflects a portion of the light 24A from the light source 26 and directs the light 24B towards the edge portion 22A of the optically clear adhesive 22. In a typical embodiment, the gap between the interior surface 20 of the housing 16 and the display assembly 14 is about 0.3 mm.

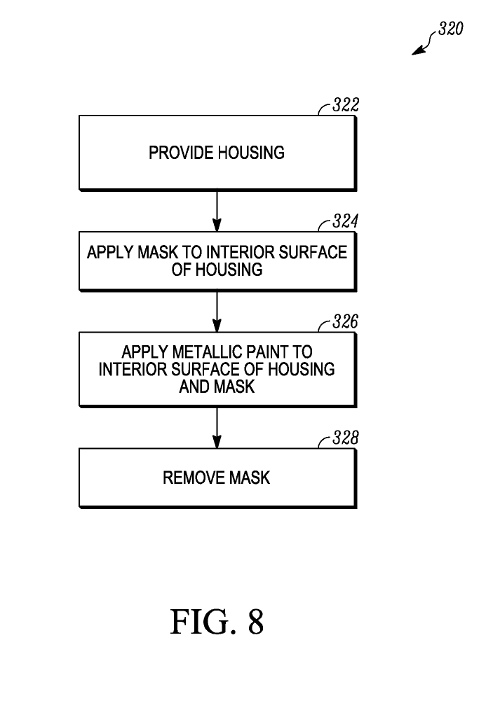

As illustrated in FIGS. 1 and 2, the reflective surface 30 is a reflective paint 30A applied to the interior surface 20 of housing 16. In an exemplary embodiment, the reflective paint 30A is a metallic or metallic-colored paint. As illustrated in the exemplary embodiment shown in FIGS. 1 and 2, the reflective paint 30A may be applied to a large portion or majority of interior surface 20 to increase the amount of light 24A reflected back as light 24B to cure the edge portion 22A of optically clear adhesive 22. A typical thickness of the reflective paint 30A is from about 0.01 to about 0.04 mm. In some exemplary embodiments, applying a thin layer of paint allows for a thinner overall dimension of housing 16, allowing lens assembly 12 to extend closer to the perimeter of sub-assembly 10. As described in reference to FIG. 8 below, a mask (not shown) may be used in the application of reflective paint 30A to minimize or prevent the application of reflective paint 30A on display assembly 12 and/or undesired portions of housing 16.

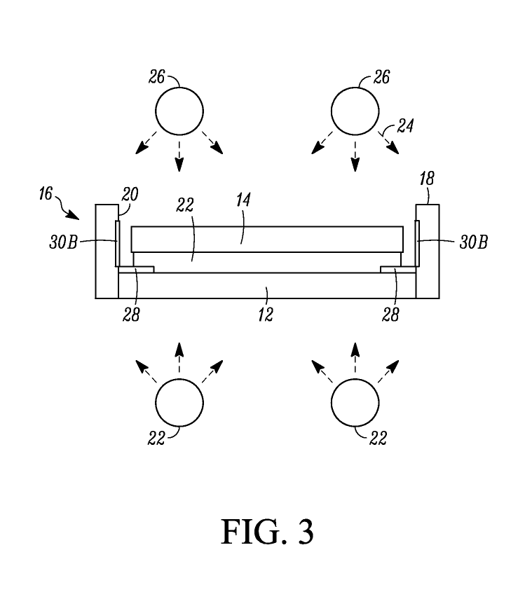

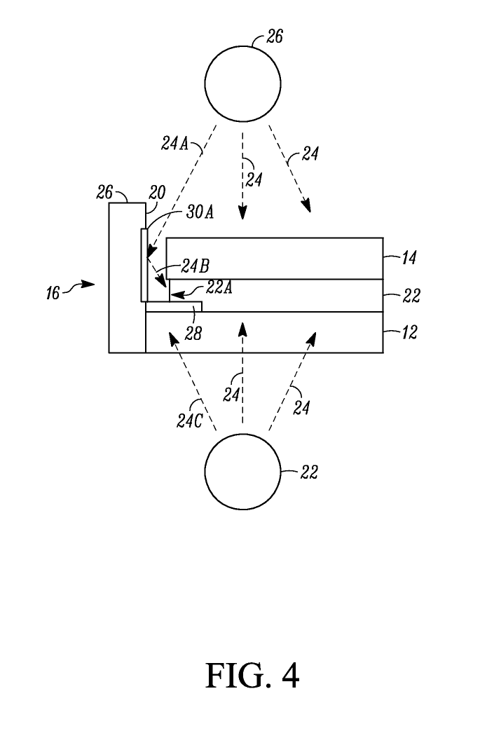

Referring next to FIGS. 3 and 4, another exemplary reflective surface 30 is illustrated. In FIGS. 3 and 4, housing 16 includes a reflective insert 30B. In one exemplary embodiment, reflective insert 30B includes a polymeric film, such as a film formed from PET or other suitable polymeric material. As illustrated in the exemplary embodiment shown in FIGS. 3 and 4, the reflective insert 30B may cover a large portion or majority of interior surface 20 to increase the amount of light 24A reflected back as light 24B to cure the edge portion 22A of optically clear adhesive 22. A typical thickness of the reflective insert 30B is about 0.1 mm.

In one exemplary embodiment, the reflective insert 30B is coupled to housing 16 by insert molding housing 16 around reflective insert 30B. In a more particular embodiment, as described in more detail with respect to FIG. 9 below, reflective insert 30B is coupled to housing 16 by insert molding housing 16 to reflective insert 30B and lens assembly 12. Reflective insert 30B may include a suitable backing material to provide stiffness to reflective insert 30B to withstand the insert molding process.

In another exemplary embodiment, the reflective insert 30B is coupled to housing 16 by an adhesive (not shown) coupling the reflective insert 30B to a pre-formed housing 16.

In some exemplary embodiments, use of a reflective insert 30B may allow for a higher utilization rate of reflective material and a more consistent thickness of the reflective surface 30.

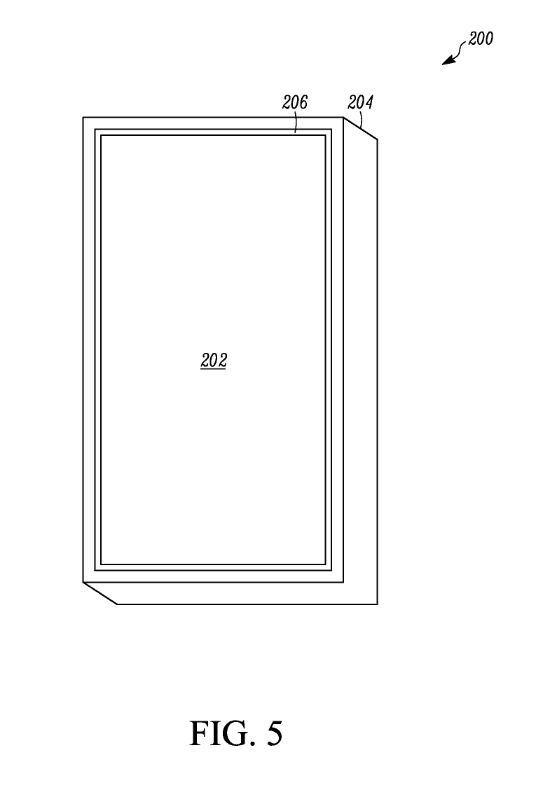

FIG. 5 is a schematic showing a mobile electronic device 200 having a display 202 and housing 204 including an interior reflective surface 30. Display 202 illustratively includes cosmetic ink 206 around a perimeter of display 202.

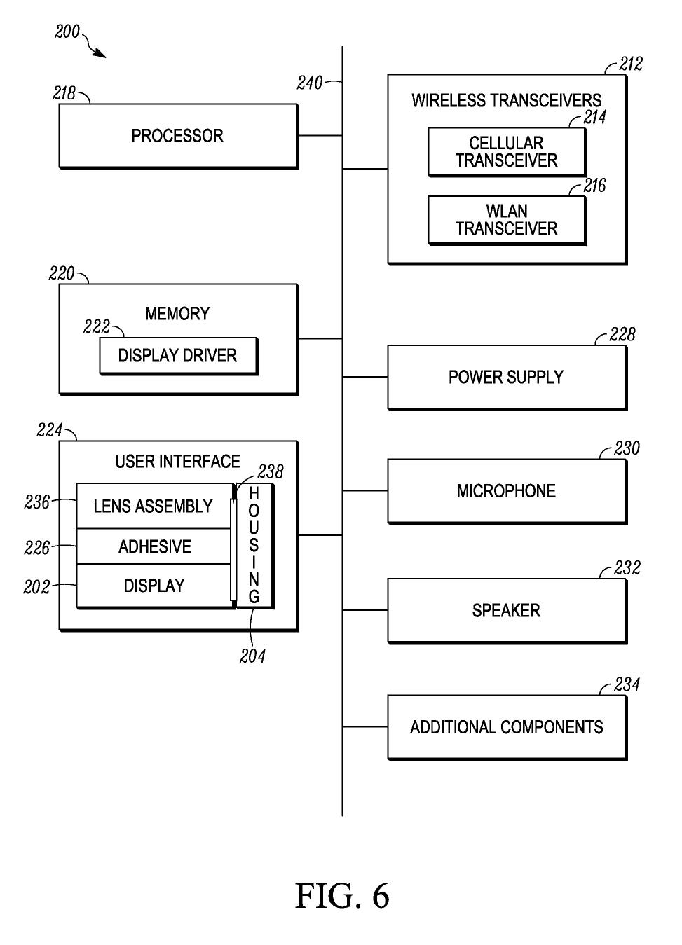

FIG. 6 is a block diagram showing illustrative components of the exemplary mobile electronic device 200 of FIG. 5. The mobile electronic device 200 includes wireless transceivers 212 for communication with external networks. In the illustrated embodiment, wireless transceivers 212 include cellular transceivers 214 and a wireless area local network (WLAN) transceiver 216. Mobile electronic device 200 further includes a processor 218, such as a microprocessor, microcomputer, application-specific integrated circuit, etc., having access to a memory portion 220. Memory portion 220 includes a driver 222 for the display 202 of mobile electronic device 200. Mobile electronic device 200 further includes a user interface 224. User interface 224 illustratively includes display 202 and a lens assembly 236. As illustrated in FIG. 6, the lens assembly 236 and display 202 are coupled by an adhesive 226. As further illustrated in FIG. 6, a reflector 238 contained in housing 204 is provided to direct light to cure adhesive 226. Mobile electronic device 200 further includes a power supply 228, such as a battery, for providing power to mobile electronic device 200. Mobile device illustratively also includes input devices, such as microphone 230, and output devices, such as speaker 232. Mobile electronic device 200 may also include additional components 234. Exemplary additional components 234 include, but are not limited to, location sensing components, such as a Global Positioning System receiver, a triangulation receiver, an accelerometer, and a gyroscope, a camera, additional inputs, such as flip sensors, keyboards, keypads, touch pads, capacitive sensors, motion sensors, and switches, and other suitable components. Each of the internal components of mobile electronic device 200 can be coupled to one another and in communication with one another by way of one or more internal communication links 240, such as an internal bus. In the illustrative embodiment of mobile electronic device 200 shown in FIG. 5, housing 204 illustratively surrounds and protects the processor 218, memory 220, user interface 224, wireless transceivers 212, power supply 228, microphone 230, speaker 232, and additional components 234 of mobile electronic device 200.

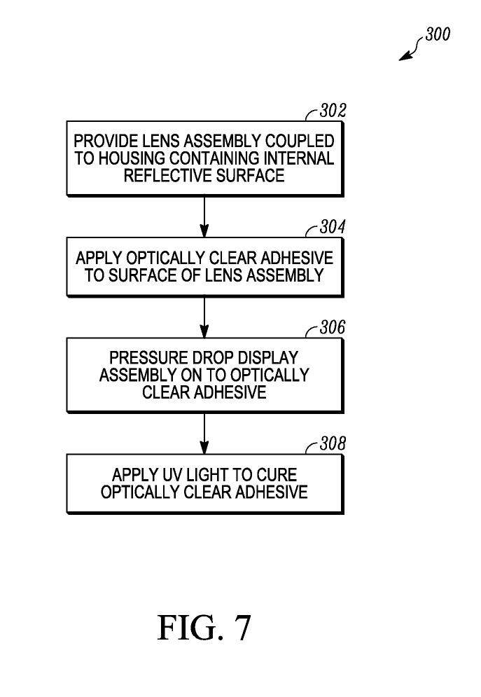

An exemplary process 300 for making a mobile electronic device 200 including an internal reflective surface 30 is provided in FIG. 7. The process 300 may be useful in forming a housing 16 including reflective paint 30A (FIGS. 1,2) and in forming a housing 16 including a reflective insert molded 30B into the housing 16 (FIGS. 3,4).

A lens assembly, such as lens assembly 12, is provided coupled to a housing, such as housing 16, in step 302. The housing 16 illustratively includes a reflective internal surface 30, such as the reflective paint 30A (FIGS. 1,2) or a reflective insert 30B (FIGS. 3,4). The lens assembly 12 is illustratively coupled to the housing 16 through an adhesive, an insert molding process, mechanical means, or other suitable coupling methods. The lens assembly 12 may include cosmetic ink 28 on the top surface.

In step 304, an optically clear adhesive 22 is applied to the top surface of the lens assembly 12. In step 306, a display assembly, such as display assembly 14, is pressure dropped on to the optically clear adhesive 22 to form an uncured sub-assembly, such as sub-assembly 10 (FIGS. 1-4).

In step 308, the optically clear adhesive 22 is cured by applying UV light 24 to the sub-assembly 10. At least a portion of the optically clear adhesive 22 is cured by UV light 24 reflecting off the reflective internal surface 30 of the housing 16.

An exemplary process 320 for applying a reflective paint 30A to a housing 16 is provided in FIG. 8. The housing 16 produced by process 320 may be provided as the housing 16 in step 302 of process 300.

In step 322, a housing, such as housing 16, is provided. In an embodiment, the housing 16 may be coupled to a lens assembly, such as lens assembly 12. In an illustrative embodiment, the housing 16 is coupled to the lens assembly 12 by insert molding the housing 16 around lens assembly 12. Other suitable coupling means, including adhesives, mechanical couplers, and friction fitting, may also be used. In another embodiment, housing 16 is not coupled to lens assembly 12 until after the completion of process 320.

In step 324, a mask (not shown) is applied to an interior surface 20 of housing 16. The mask partially covers the interior surface 20 of housing 16. When housing 16 is attached to lens assembly 12 during process 320, the mask may cover a portion of lens assembly 12.

In step 326, a reflective paint 30A is applied to the interior surface 20 of housing 16. The mask prevents the paint from being applied to the lens assembly 12 and restricts the application to only a desired area of the housing 16.

In step 328, the mask is removed and the reflective paint 30A is allowed to dry.

An exemplary process 340 for insert molding a housing, such as housing 16, around a reflective insert, such as reflective insert 30B, is provided in FIG. 9. The housing 16 produced by method 340 may be provided as the housing 16 in step 302 of process 300.

In step 342, a lens assembly, such as lens assembly 12, is provided.

In step 344, a reflective insert, such as reflective insert 30B, is provided. In an embodiment, the reflective insert 30B may be a polymeric film, such as polyethylene terephthalate (PET), available under the trade name Mylar. The reflective insert 30B and lens assembly 12 are positioned in a mold.

In step 346, a plastic housing, such as housing 16, is formed by insert molding the housing 16 to both the lens assembly 12 and reflective insert 30B.

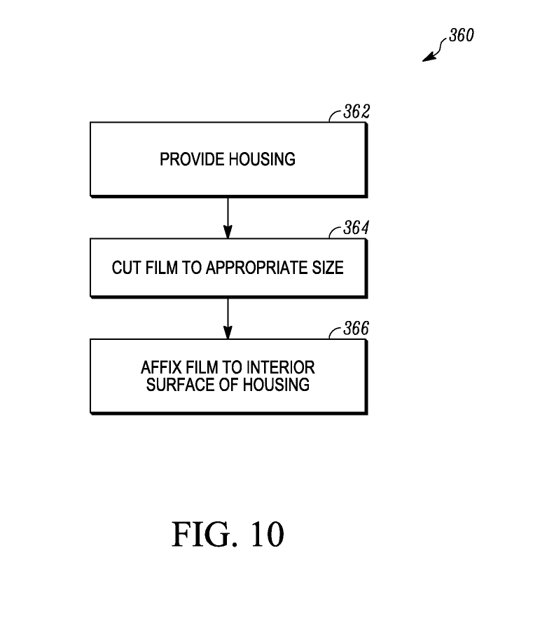

An exemplary process 360 for affixing a reflective material, such as reflective insert 30B, is provided in FIG. 10. The housing 16 produced by method 360 may be provided as the housing 16 in step 302 of process 300.

In step 362, a lens assembly, such as lens assembly 12, is provided. In an embodiment, the housing 16 may be coupled to a lens assembly, such as lens assembly 12. In an illustrative embodiment, the housing 16 is coupled to the lens assembly 12 by insert molding the housing 16 around lens assembly 12. Other suitable coupling means, including adhesives, mechanical couplers, and friction fitting, may also be used. In another embodiment, housing 16 is not coupled to lens assembly 12 until after the completion of process 320.

In step 364, a reflective insert, such as reflective insert 30B, is cut to size. In an embodiment, the reflective insert 30B may be a polymeric film, such as polyethylene terephthalate (PET), available under the trade name Mylar.

In step 366, the reflective insert 30B is affixed to the interior surface 20 of housing 16 by using adhesives, mechanical couplers, or other suitable coupling means.

In summary, persons of ordinary skill in the art will readily appreciate that methods and apparatus for curing an optically clear adhesive have been provided. Among other advantages, the disclosed methods and apparatus provide for curing of portions of the adhesive that are not directly accessible by UV light. In addition, the disclosed methods and apparatus provide for decreased failures due to de-lamination of the lens and display assemblies.

The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method for curing a light-cured adhesive comprising:
providing the adhesive between a first surface and a second surface; and
curing the adhesive by applying a light to the adhesive, where at least a portion of the adhesive is cured by light reflecting off a reflector coupled to the first surface.

2. The method of claim 1, wherein the reflector is substantially perpendicular to the first surface.

3. The method of claim 1, wherein the adhesive is an optically clear adhesive.

4. The method of claim 1, wherein the reflector is a first layer of reflective paint applied to a wall that is coupled to the first surface.

5. The method of claim 1, wherein the reflector comprises a polymeric film coupled to a wall that coupled to the first surface.

6. The method of claim 1, further comprising the steps of:
forming a wall around the reflector by an insert molding process; and
coupling the wall to the first surface.

7. The method of claim 1, further comprising the steps of:
covering a first portion of the wall with a mask, wherein a second portion of the wall is not covered by the mask;
applying the first layer of reflective paint to the mask and second portion of the wall; and
removing the mask from the wall.

8. The method of claim 1, wherein the first surface includes an opaque portion.

9. The method of claim 1, wherein the first surface is a portion of a lens assembly and the second surface is a portion of a display assembly.

10. The method of claim 1, wherein the light is ultra-violet light.

11. A sub-assembly for an electronic device comprising:
a lens assembly;
a display assembly;
an optically clear adhesive coupling the lens assembly to the display assembly, the optically clear adhesive being cured by exposure to a light source;
a housing surrounding the lens assembly and display assembly; and
a light reflector coupled to the housing, wherein the light reflector is configured to reflect light from the light source towards the optically clear adhesive to cure a portion of the optically clear adhesive.

12. The sub-assembly of claim 11, wherein the housing includes a first wall substantially perpendicular to the lens assembly, the light reflector being coupled to the first wall.

13. The sub-assembly of claim 11, wherein the light reflector comprises a reflective paint applied to the housing.

14. The sub-assembly of claim 11, wherein the light reflector is formed from a polymeric material.

15. The sub-assembly of claim 14, wherein the housing is insert molded around the polymeric material.

16. The sub-assembly of claim 11, further comprising an opaque layer positioned between a portion of the lens assembly and a portion of the optically clear adhesive.

17. The sub-assembly of claim 16, wherein the portion of the optically cured adhesive cured by the light reflected by the light reflector is adjacent to the opaque layer.

18. A mobile electronic device comprising:
a lens assembly;
a display assembly;
an optically clear adhesive coupling the lens assembly to the display assembly, the optically clear adhesive being cured by exposure to a light source;
a battery providing power to the display assembly;
a housing surrounding the lens assembly display assembly, and battery; and
a light reflector coupled to the housing, wherein the light reflector is configured to reflect light from the light source towards the optically clear adhesive to cure a portion of the optically clear adhesive.

19. The mobile electronic device of claim 18, wherein the light reflector comprises a reflective paint applied to the housing.

20. The mobile electronic device of claim 18, wherein the light reflector is formed from a polymeric material and the housing is insert molded around the polymeric material.
